(19) United States
(12) Patent Application Publication
(10) Pub. No.: US 2013/0037559 A1
(43) Pub. Date: Feb. 14, 2013

(54) BUCKET TOOL ORGANIZER WITH TOOL INSERT

(71) Applicant: David P. Fierek, Moundsview, MN (US)

(72) Inventor: David P. Fierek, Moundsview, MN (US)

(73) Assignee: BOSS INNOVATIONS, INC., Moundsview, MN (US)

(21) Appl. No.: 13/418,287

(22) Filed: Mar. 12, 2012

Related U.S. Application Data
(63) Continuation of application No. 12/170,211, filed on Jul. 9, 2008, now abandoned.
Application No. 12/170,211 is a continuation of application No. 10/811,282, filed on Mar. 25, 2004, now abandoned.

(51) Int. Cl. B25H 3/00

(52) U.S. Cl. 220/735

(57) ABSTRACT

Bucket tool organizers useful for transporting and storing tools and other utensils are disclosed. A bucket tool organizer in accordance with an exemplary embodiment may include a bucket mounted tool carrier adapted to contour about a container such as a bucket or pail, and a tool insert situated within the interior of the container. The bucket mounted tool carrier may include a number of pockets located on both an interior and exterior panel member that can be used to store objects therein. The tool insert may include a contoured holster situated within the interior of the container to store larger items such as power tools or the like.

### RELATED APPLICATIONS

This is a continuation application of U.S. patent application Ser. No. 12/170,211 filed Jul. 9, 2008, which is a continuation application of U.S. patent application Ser. No. 10/811,282 filed Mar. 25, 2004.

### FIELD OF THE INVENTION

The present invention relates to tool carriers and inserts. More specifically, the present invention pertains to bucket tool organizers useful for transporting and storing tools, utensils, or other useful implements.

### BACKGROUND OF THE INVENTION

Bucket tool organizers (BTO's) are useful devices for transporting and storing tools, utensils, or other useful implements. Such devices typically include a bucket mounted tool carrier having a shape that conforms generally to the surfaces of an empty container such as a bucket or pail. In certain designs, the bucket mounted tool carrier may comprise a generally cylindrical-shaped article manufactured from a fabric-like material such as canvas or nylon that can be draped over the container, converting the container into a storage device capable of holding tools, utensils, fasteners, and other such objects. A number of individual pockets or dividers arranged about both the interior and/or exterior portions of the container can be used to quickly store and organize variously sized objects for later access.

While a myriad of designs have been developed to convert existing containers into bucket tool organizers, many such designs are incapable of storing larger tools or utensils. For example, in those designs having pockets or dividers that drape over the converted container, relatively large tools such as power drills, portable electric sanders, hammers, or the like may cause the bucket to become off-balanced and destabilized. This problem is particularly evident when the tool to be inserted does not contour well with the shape of the pocket, causing the tool to move within the pocket and destabilize the container. Accordingly, there is a need in the art for a bucket tool organizer adapted to transport and store larger tools and utensils with increased stability, functionality, and ease of use.

### SUMMARY OF THE INVENTION

The present invention pertains to bucket tool organizers useful for transporting and storing tools, utensils, or other useful implements. A bucket tool organizer in accordance with an exemplary embodiment of the present invention may include a bucket mounted tool carrier adapted to contour about a container such as a bucket or pail, and a tool insert that can be situated within the interior of the container to store relatively large objects such as power tools. The bucket mounted tool carrier may include a cylindrically shaped interior panel member configured to drape over and extend into the interior of the container, and an exterior panel member coupled to the interior panel member configured to drape over the exterior of the container. A number of pockets arranged about both the interior and exterior panel members may be used for storing various objects therein.

The tool insert may include a contoured holster having a shape configured to tightly receive relatively large tools such as power drill, portable electric sanders, hammers, or the like. The contoured holster may include a number of panel members that conform generally to the size and shape of the tool to be inserted therein. In certain embodiments, the tool insert may be removably situated within the container using a set of clips or other suitable fastening means, allowing the device to be used alone or in combination with the bucket mounted tool carrier. In other embodiments, the tool insert may be fixedly secured to the bucket mounted tool carrier by stitching or other suitable attachment means. Since the tool insert is situated within the interior of the container, the weight of the inserted tool is distributed more towards the centroid of the container, providing greater stability to the device. Moreover, since the tool is held stationary within the contoured holster, instability caused by shifting of the tool within the holster is further ameliorated.

### BRIEF DESCRIPTION OF THE DRAWINGS

FIG. 1 is a front perspective view of an illustrative bucket tool organizer draped over a container;

FIG. 2 is a rear perspective view of the bucket tool organizer and container of FIG. 1;

FIG. 3 is a cut-away perspective view showing the interior of the bucket tool organizer and container of FIGS. 1-2;

FIG. 4 is an upper-front perspective view of an illustrative tool insert;

FIG. 5 is a lower-rear perspective view of the illustrative tool insert of FIG. 4;

FIG. 6 is a cut-way perspective view showing the tool insert attached to the bucket tool organizer and container of FIGS. 1-3;

FIG. 7 is a cut-way perspective view showing the tool insert attached to the bucket tool organizer, a tool box and container of FIGS. 1-3;

FIG. 8 is an enlarged partial cross-sectional view showing the attachment of the tool insert to the bucket tool organizer and container of FIGS. 1-3; and

FIG. 9 is a cut-away perspective view of another illustrative bucket tool organizer draped over a container.

### DETAILED DESCRIPTION OF THE INVENTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

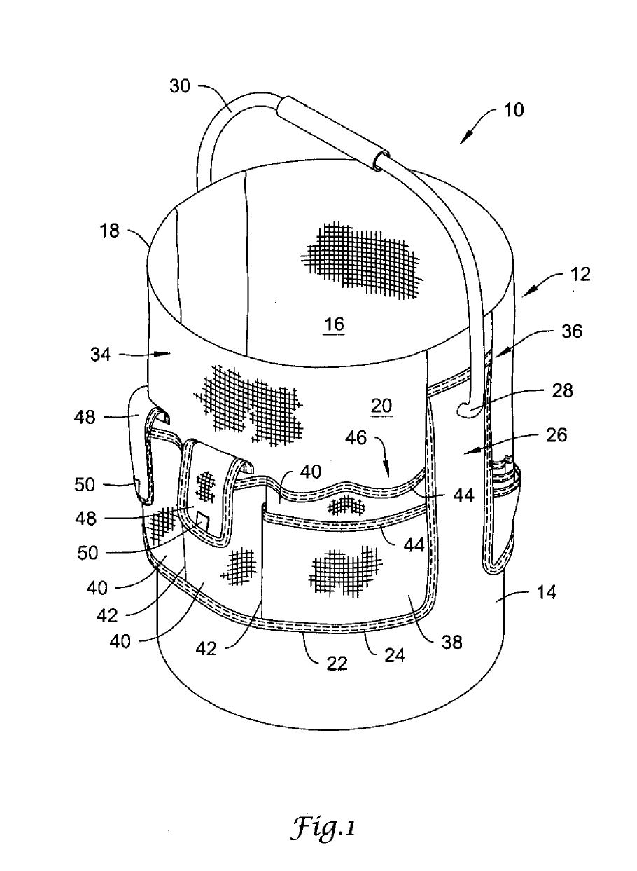

FIG. 1 is a front-perspective view of a bucket tool organizer 10 in accordance with an exemplary embodiment of the present invention. Bucket tool organizer 10 includes a bucket mounted tool carrier 12 adapted to contour about an existing container 14 such as a bucket, pail, or the like to permit the transport and storage of tools, utensils, fasteners, and other frequently used objects. The tool carrier 12 may include a generally cylindrical-shaped interior panel member 16 configured to drape over the upper rim 18 of the container 14 and extend downwardly to cover all or a portion of the inside surface of the container 14. The tool carrier 12 may be made from a supple, wear-resistant fabric or cloth material such as canvas or nylon that can be easily adjusted to contour about containers of various size and shape. Examples of suitable materials may include 6.6 nylon, 600 denier fabric, Cordura® nylon yarn or twin from the E.I. Dupont de Nemours & Co., Inc. of Wilmington, Del., or ANSO®-tex nylon fiber from Honeywell, Inc. of Morristown, N.J. Other pliable sheet or film materials such as polyolefins or other the like may also be satisfactory.

An exterior panel member 20 formed from the same piece of material forming the interior panel member 16 may be draped over the upper rim 18 of the container 14 and extend downwardly over all or a portion of the exterior surface of the container 14. The bottom edge 22 of the exterior panel member 20 may be configured to lie essentially flat against the exterior surface of the container 14, and is bound by stitching represented generally by reference number 24.

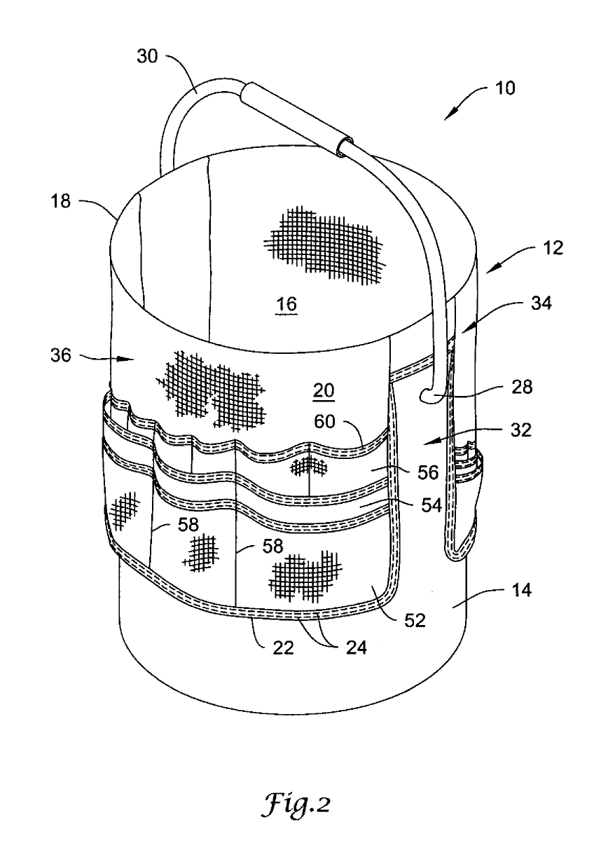

A slotted section 26 extending upwardly from the bottom edge 22 upwardly above the base 28 of the container handle 30 allows the exterior panel member 20 to lie flush about the exterior surface of the container 12 without interfering with the operation of the handle 30. A similar slotted section 32 (see FIG. 2) on the opposite side of the exterior panel member 20 prevents obstruction with the base 28 for the other side of the handle 30. The slots 26,32 located on each side of the exterior panel member 20 divide the member 20 into essentially two sections 34,36, each located on opposite sides of container handle 30.

The exterior panel member 20 may include a plurality of pockets of varying width and height that can be used to store various objects therein. As shown in FIG. 1, the first section 34 of the exterior panel member 20 may include one or more lower pockets 38, and one or more upper pockets 40 that can be used to store objects therein. Each pocket 38,40 may be formed by sewing pieces of fabric cloth or other suitable material to the exterior panel member 20. Each pocket 38,40 may be demarcated by vertical stitch lines 42 that define the vertical boundaries of the pockets 38,40, and horizontal stitch lines 44 that define the horizontal boundaries of the pockets 38,40. In some cases, a portion of the stitching used to form the pockets 38,40 will be common with the stitching used to form the bottom stitching 24 and the slots 26,32. A pocket opening 46 for each pocket 38,40 opens upwardly to allow tools, utensils, or other objects to be inserted from above. Certain of the pockets 38,40 may also include a closable flap 48 that can be used to seal the pocket to prevent objects from falling out during transport. A Velcro® tab 50, snap fitting, button, hook, zipper, or other suitable fastener may be utilized to secure the flap 48 to the exterior of the pocket.

FIG. 2 is a rear perspective view showing the bucket tool organizer 10 and container 14 of FIG. 1. As shown in FIG. 2, the second section 36 of the exterior panel member 20 may include one or more lower pockets 52, middle pockets 54, and upper pockets 56, each of which can be used to store variously sized objects therein. As with the pockets 38,40 on the first section 34, each tier of pockets 52,54,56 may be formed by sewing pieces of fabric cloth or other suitable material to the exterior panel member 20. The pockets 52,54,56 may be demarcated by several vertical stitch lines 58 and horizontal stitch lines 60 that define, respectively, the vertical and horizontal boundaries of the pockets 52,54,56. In some cases, a portion of the stitching used to form the pockets 52,54,56 will be common with the stitching 24 used to form the bottom edge 22 and the slots 26,32.

Although a specific arrangement of pockets is depicted in FIGS. 1-2, it should be understood that other pocket configurations are possible. The size and shape of the pockets can be selected to hold certain types of items in any variety of positions. In certain embodiments, for example, the pockets may have an open-bottom design that allows access to the tool from a location either above or below the pocket. In other embodiments, the pockets may be pleated to permit the pocket to expand, allowing the insertion of larger sized items.

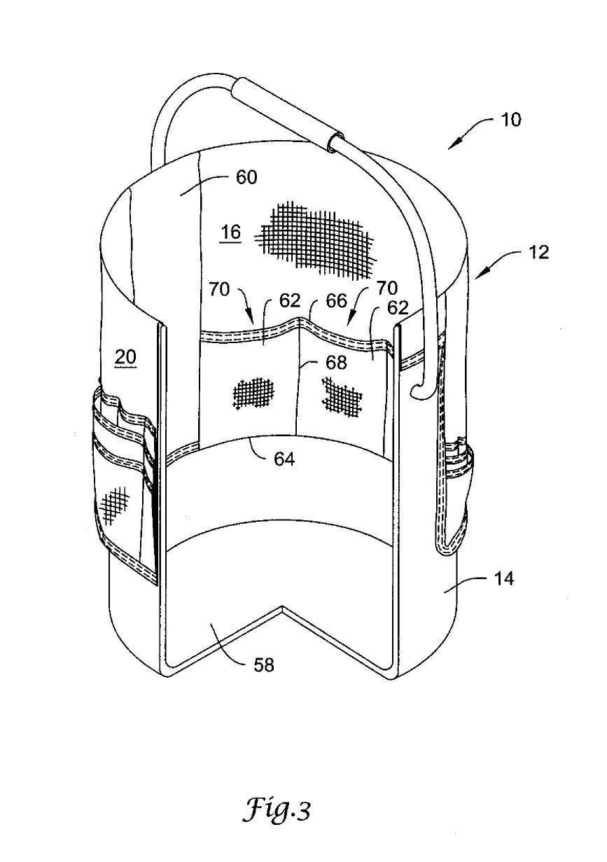

FIG. 3 is a cut-away perspective view showing the interior of the bucket tool organizer 10 and container 14 of FIGS. 1-2. As shown in FIG. 3, the interior panel member 16 is configured to conform generally to the interior surface of the container 14, and extends downwardly towards the bottom surface 58 of the container 14. A pleated section 60 of the interior panel member 16 may be provided to permit the tool carrier 12 to stretch and conform to variously sized containers 14.

The interior panel member 16 may further include a number of pockets 62 that can be used to transport and store various items within the interior of the container 14. The pockets 62 may be formed by an extension of the interior panel member 16 that has been folded upwardly at a lower edge 64 that forms the lower boundary of the pockets 62 to an upper edge 66 that forms the upper boundary of the pockets 62. A number of vertical stitch lines 68, in turn, define the vertical boundaries of the pockets 62. A pocket opening 70 for each pocket 62 opens upwardly to allow tools or other objects to be inserted from above. As with other pockets discussed herein, a closable flap (not shown) may be further provided to seal one or more of the pockets 62, if desired.

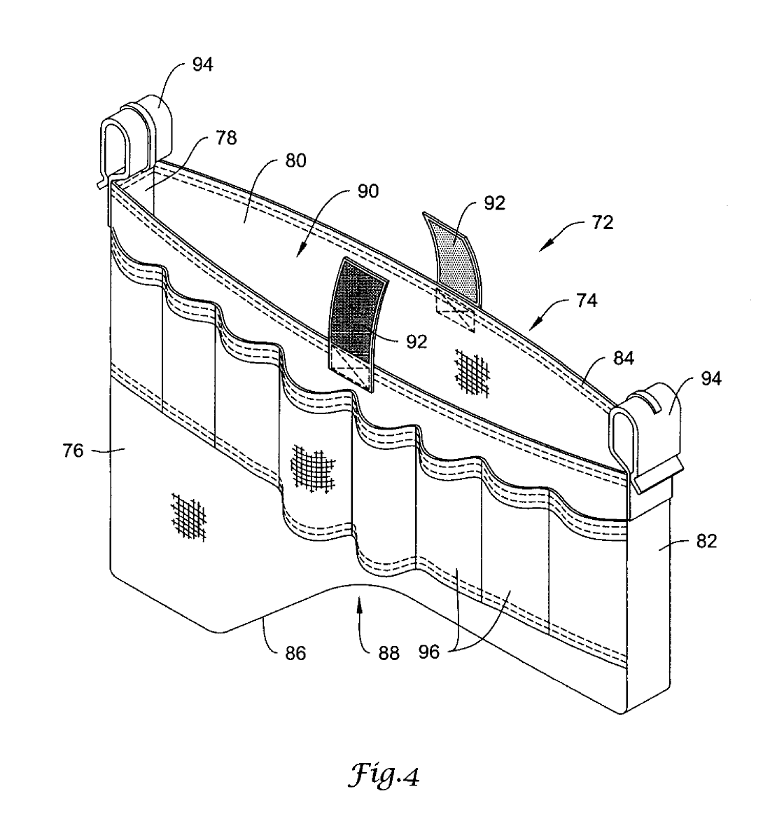

Referring now to FIG. 4, an illustrative tool insert 72 for use with a bucket tool organizer will now be described. The tool insert 72 may comprise a contoured holster 74 having a first side panel 76, a first end panel 78, a second side panel 80, and a second end panel 82. The various panel members defining the contoured holster 74 may be formed from a cloth material such as canvas or nylon that is sewn together along a number of stitch lines, represented generally by reference number 84. In an alternative embodiment (not shown), the tool insert 72 may be formed from a blank of polymeric material that can be molded to a particular shape, as desired.

The contoured holster 74 may have a particular shape that corresponds generally to the shape of a relatively large tool such as the power drill. In the exemplary embodiment depicted in FIG. 4, for example, the bottom boundary 86 of the contoured holster 74 may include a necked-down region 88 that is contoured to the shape of the tool when inserted into the holster 74. An opening 90 on the top of the contoured holster 74 allows the insertion of the tool from above. The size and shape of the various panel pieces and the opening 90 can, of course, vary depending on the particular tool to be inserted into the holster 74. A set of Velcro® tabs 92 or other suitable fastening means located along the upper portion of the contoured holster 74 may be further provided to prevent inadvertent movement of the tool once inserted therein.

A set of clips 94 attached to the end panels 78,82 may be used to secure the tool insert 72 to the upper rim 18 of the container 14, thereby converting the container 14 into a device suitable for use in transporting and storing relatively large tools. The tool insert 72 can be configured to fit within the interior of the container 14, and may be used either exclusively or with the bucket mounted tool carrier 12 to store tools and other useful implements. In certain embodiments, the tool insert 72 may include several side pockets 96 for the storage of smaller objects along the exterior of the contoured holster 74. The pockets 94 may vary in dimension and style (e.g. open bottom, pocket style, etc.), and may be arranged about one or both side panels 76,80 of the contoured holster 74, as desired.

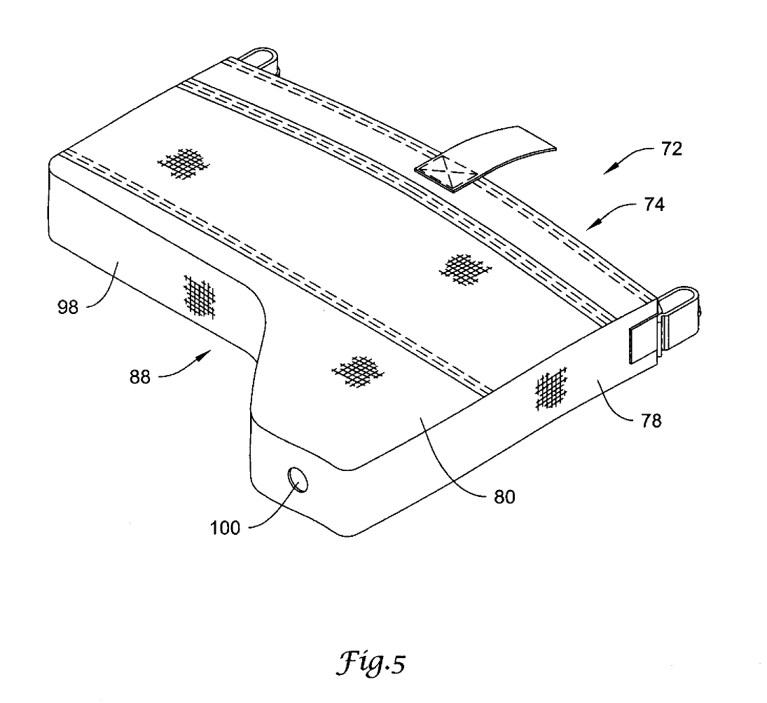

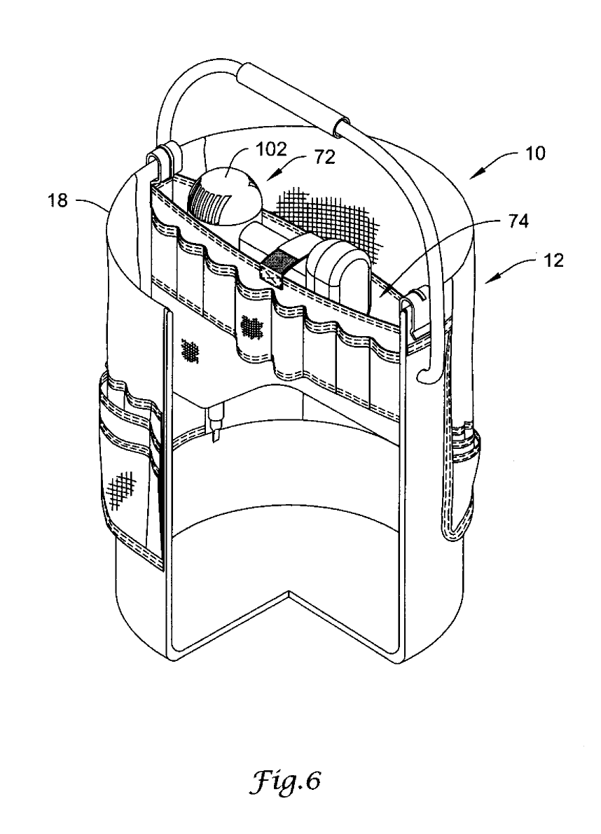

FIG. 5 is a lower-rear perspective view of the tool insert 72 of FIG. 4, showing the bottom portion of the tool insert 72 in greater detail. As shown in FIG. 5, a bottom panel 98 of the contoured holster 74 may have a substantially closed configuration with a tapering shape that forms the necked-down region 88. An eyelet 100 disposed through the bottom panel 98 may be provided to permit a portion of the inserted tool to extend partially below the bottom panel 96, as shown, for example, in FIG. 6. In those embodiments wherein a power drill is to be inserted into the contoured holster 74, for example, the eyelet 100 allows the drill bit to be inserted through the bottom panel 98, further holding the tool in place.

FIG. 6 is a cut-way perspective view showing the tool insert 72 attached to the tool carrier 12 and container 14 of FIGS. 1-3. Tool insert 72 can also be placed on container 14 without tool carrier 12. As shown in FIG. 6, the tool insert 72 is configured to attach to the upper rim 18 of the container 14, and may be used to store a relatively large tool such as power drill 102. When attached thereto, the tool insert 72 suspends the tool 102 within a central interior portion of the container 14. The positioning of the tool 102 at this location is significant since the weight is distributed at or near the centroid of the container 14, providing greater stability to the device. Moreover, since the tool 102 is held stationary within the contoured holster 74, instability caused from shifting of the tool 102 within the holster 74 during transport is further reduced or eliminated.

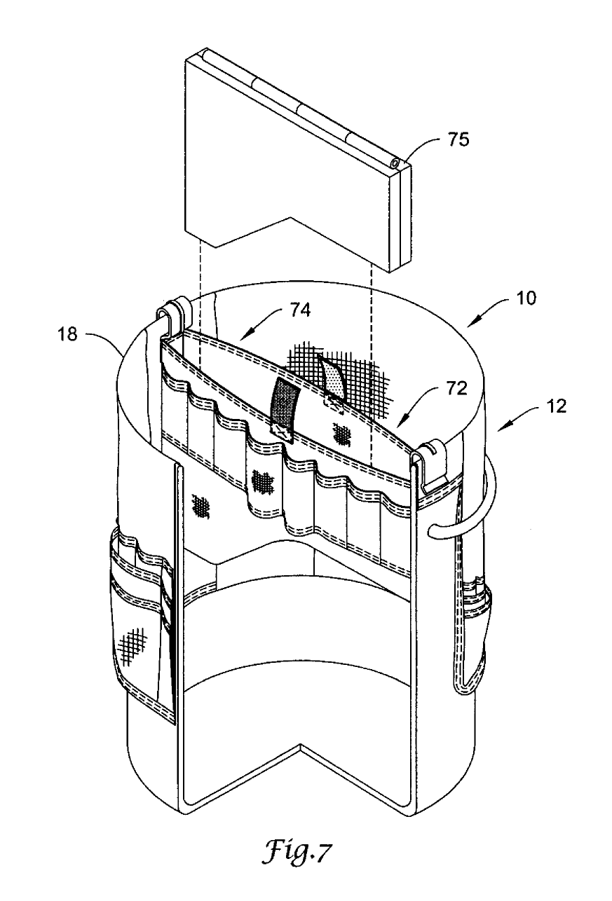

FIG. 7 is a cut-away perspective view showing tool insert 72 attached to the tool carrier 12 as shown in FIG. 6. Here, however, rather than showing a tool such as power drill 102 inserted within holster 74, a toolbox 75 is shown. Toolbox 75 can be configured to conform to the shape of holster 74 as shown.

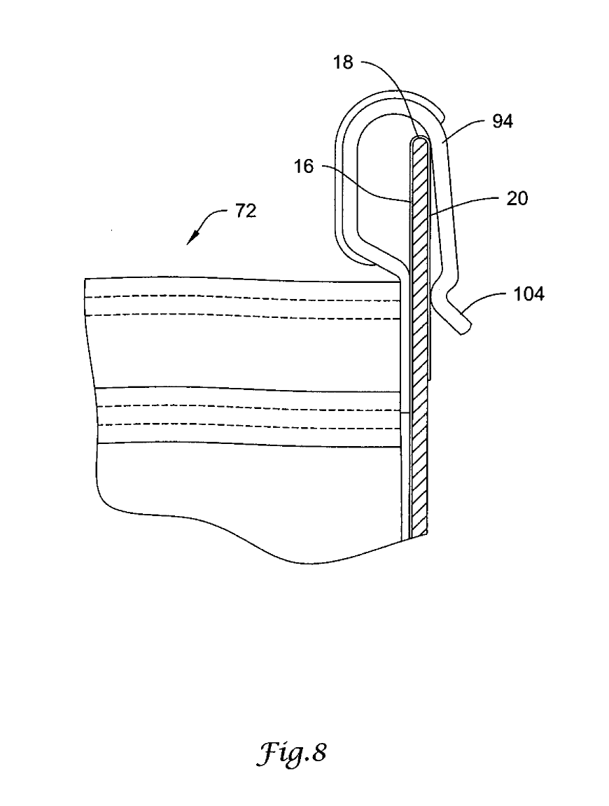

FIG. 8 is an enlarged partial-cross sectional view showing the attachment of the tool insert 72 to the tool carrier 12 and container 14. As shown in FIG. 8, each clip 94 may be adapted to engage and secure the tool insert 72 to the upper rim 18 of the container 14 and to the exterior panel member 20 of the tool carrier 12. In addition to securing the tool insert 72 to the container 14, clip 94 further serves the purpose of holding the tool carrier 12 in place about the upper rim of the container 14. A leading end 104 of each clip 94 may be flared slightly to facilitate attachment of the clip 94 about the upper rim 18 of the container 14 and exterior panel member 20.

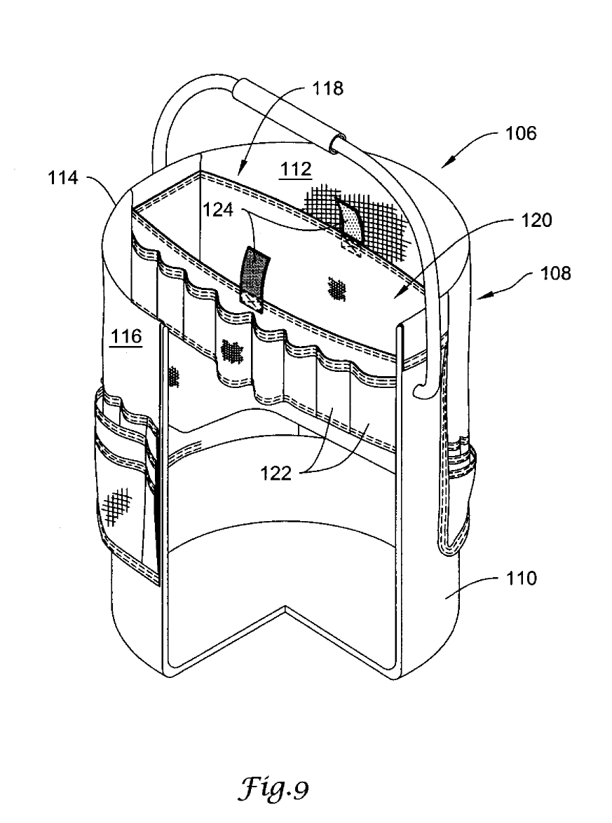

FIG. 9 is a front perspective view of an illustrative bucket tool organizer 106 in accordance with another exemplary embodiment of the present invention. Bucket tool organizer 106 is similar in construction to the bucket tool organizer 10 discussed above, including a bucket mounted tool carrier 108 adapted to contour about an existing container 110 such as a bucket, pail, or the like to permit the transport and storage of tools, utensils, fasteners, and other frequently used objects. The tool carrier 108 may include a generally cylindrical-shaped interior panel member 112 configured to drape over the upper rim 114 of the container 110 and extend downwardly to cover all or a portion of the inside surface of the container 110. An exterior panel member 116 formed from the same piece of material forming the interior panel member 112 drapes over all or a portion of the exterior surface of the container 110.

In the exemplary embodiment of FIG. 9, the tool insert 118 is shown fixedly secured to the interior panel member 112 at a location slightly below the upper rim 114 of the container 110, eliminating the need for separate clips. The tool insert 118 may include a contoured holster 120 having a similar construction to the contoured holster 74 discussed above with respect to FIGS. 4-5. For example, the contoured holster 120 may have a shape that corresponds generally to the shape of a relatively large tool (e.g. a power drill). Other features discussed herein, including exterior pockets 122 and a set of Velcro® fastening tabs 124 may further be implemented, as desired.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes may be made in details, particularly in matters of shape, size and arrangement of parts without exceeding the scope of the invention.

What is claimed is:

1. A bucket tool organizer, comprising:
a tool insert situated within the interior of a container having an upper end, an opening near the upper end, a closed lower end, and a side wall, said tool insert including a holster substantially spanning the opening having a shape configured to tightly receive an object therein, the shape being bounded by first and second side panels, first and second end panels, and a bottom panel, the first and second side panels and the first and second end panels extending from an upper end of the holster to the bottom panel, the holster upper end being recessed from the upper end of the container, wherein the holster is formed from a fabric or cloth material.

2. The bucket tool organizer of claim 1, wherein the bottom panel of said tool insert includes a first region proximate the first end panel and a second region proximate the second end panel, the second region being flat and parallel to the top end of the holster and the first region being further from the top end of the holster than the second region.

3. The bucket tool organizer of claim 2, wherein the first region is flat and parallel to the top end of the holster.

4. The bucket tool organizer of claim 3, wherein the bottom panel further comprises a third region disposed between the first region and the second region, the third region being planar and at an obtuse angle to the first region and the second region.

5. The bucket tool organizer of claim 1, further comprising an eyelet disposed through the bottom panel, the eyelet being spaced equally from the first side wall and the second side wall.

6. The bucket tool organizer of claim 1, wherein the tool insert includes one or more pockets attached to one or both of said first and second side panels.

7. The bucket tool organizer of claim 1, further comprising a set of clips attached to the tool insert, said set of clips adapted to releasably secure the tool insert to the upper end of the container.

8. The bucket tool organizer of claim 1, further comprising a fastening means for joining the first side panel to the second side panel over the upper end of the holster.

9. The bucket tool organizer of claim 8, wherein the fastening means comprise a first tab and a second tab, the first tab fixedly attached to the first panel and the second tab fixedly attached to the second panel.

10. The bucket tool organizer of claim 9, wherein the first and second tabs comprise hook-and-loop fastener material.

11. The bucket tool organizer of claim 8, wherein the fastening means are disposed centrally between the first end panel and the second end panel and wherein the fastening means extend for no more than 20 percent of the distance between the first end panel and the second end panel.

12. The bucket tool organizer of claim 1, wherein the first and second panels are parallel and symmetric about a plane extending through the center of the bucket.

13. The bucket tool organizer of claim 1, wherein the tool insert includes one or more pockets attached to one or both of said first and second side panels.

14. The bucket tool organizer of claim 13, wherein the one or more pockets extend from the first end panel to the second end panel.

15. The bucket tool organizer of claim 13, wherein the one or more pockets have an upper opening that is below the holster upper end.

16. The bucket tool organizer of claim 13, wherein one or more of the one or more pockets has an open bottom end.

17. The bucket tool organizer of claim 13, wherein the one or more pockets have a lower end that terminates above the bottom panel of the holster.

18. The bucket tool organizer of claim 1, wherein the holster is made from 600 denier fabric.

19. The bucket tool organizer of claim 1, wherein the fabric or cloth material is made from a nylon yarn.
